(19) United States
(12) Patent Application Publication
(10) Pub. No.: US 2013/0275717 A1
(43) Pub. Date: Oct. 17, 2013

(54) Multi-Tier Data Processing

(71) Applicants: Bruce Wilson, San Jose, CA (US); Shaohua Yang, San Jose, CA (US); Yuan Xing Lee, San Jose, CA (US); Daniel Scott Fisher, Dublin, CA (US)

(72) Inventors: Bruce Wilson, San Jose, CA (US); Shaohua Yang, San Jose, CA (US); Yuan Xing Lee, San Jose, CA (US); Daniel Scott Fisher, Dublin, CA (US)

(73) Assignee: LSI Corporation

(21) Appl. No.: 13/445,848

(22) Filed: Apr. 12, 2012

(51) Int. Cl. G06F 15/76; G06F 9/02

(52) U.S. Cl. 712/28; 712/E09.002

(57) ABSTRACT

Various embodiments of the present invention provide systems and methods for a multi-tier data processing system. For example, a data processing system is disclosed that includes an input operable to receive data to be processed, a first data processor operable to process at least some of the data, a second data processor operable to process a portion of the data not processed by the first data processor, wherein the first data processor has a higher throughput than the second data processor, and an output operable to yield processed data from the first data processor and the second data processor.

### BACKGROUND

Various data processing systems have been developed including storage systems, cellular telephone systems, and radio transmission systems. In each of the systems data is transferred from a sender to a receiver via some medium. For example, in a storage system, data is sent from a sender (i.e., a write function) to a receiver (i.e., a read function) via a storage medium. As information is stored and transmitted in the form of digital data, errors are introduced that, if not corrected, can corrupt the data and render the information unusable. The effectiveness of any transfer is impacted by any losses in data caused by various factors. Many types of data processors have been developed to detect and correct errors in digital data. For example, data detectors and decoders such as Maximum a Posteriori (MAP) detectors and Low Density Parity Check (LDPC) decoder mays be used to detect and decode the values of data bits or multi-bit symbols retrieved from storage or transmission systems.

One example of such a data processing system is a read channel designed to determine the data pattern recorded on a sector of a hard disk drive from a noisy and distorted analog signal obtained as the read head passes over that sector. The degree of impairment seen on each sector varies. As a stream of sectors is read in sequence the analog signal from some sectors will be impaired to a greater degree and from others to a lesser degree. The analog signal from some sectors will be impaired so much that the read channel cannot determine the recorded data and these sectors must be read a second time in order to recover the recorded data. During operation a hard disk drive may be operated with sufficient margin that repeatedly reading the same sector does not occur so often as to measurably reduce the net data rate of the hard disk drive.

In some cases, a sector queue memory is used such that sectors with greater impairment can be processed for a greater length of time and sectors with less impairment can be processed more quickly provided that the average processing time does not exceed the average time between sectors. This method allows efficient use of the detector with a mixture of more and less impaired sectors. However in this method sectors with greater impairment are processed in much the same way as sectors with less impairment, although they are processed for a longer time.

A need remains for a data processing system that is able to determine the data pattern in sectors with a relatively low signal to noise ratio without substantially reducing the average processing time.

### BRIEF SUMMARY

Various embodiments of the present invention provide systems and methods for a multi-tier data processing system. For example, a data processing system is disclosed that includes an input operable to receive data to be processed, a first data processor operable to process at least some of the data, a second data processor operable to process a portion of the data not processed by the first data processor, wherein the first data processor has a higher throughput than the second data processor, and an output operable to yield processed data from the first data processor and the second data processor. In some embodiments, the data to be processed is stored in an input memory before processing by the first data processor, and data that is not successfully processed by the first data processor is transferred into a second memory for processing by the second data processor. The multi-tier data processing system may yield processed data from the first and second data processors in a different order than the input order.

Some other embodiments provide a method for processing data in a multi-tier data processing system, including storing data to be processed in a first memory, processing data stored in the first memory in a first data processor, for portions of the data stored in the first memory that are not successfully processed in the first data processor, storing the portions of the data in a second memory, processing the data stored in the second memory in a second data processor, and outputting processed data from the first data processor and from the second data processor.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals may be used throughout several drawings to refer to similar components.

FIG. 1 depicts a block diagram of a multi-tier data processing system in accordance with some embodiments of the present invention;

FIG. 2 depicts a block diagram of a multi-tier data processing system with multi-tier memories in accordance with some embodiments of the present invention;

FIG. 3 depicts a block diagram of a read channel including multi-tier detectors in accordance with some embodiments of the present invention;

FIG. 4 depicts a block diagram of a read channel including multi-tier decoders in accordance with some embodiments of the present invention;

FIG. 5 depicts a flow diagram showing a method for data processing with a multi-tier data processor in accordance with some embodiments of the present invention;

FIG. 6 depicts a storage system including a multi-tier data processing system in accordance with some embodiments of the present invention; and

FIG. 7 depicts a wireless communication system including a multi-tier data processing system in accordance with some embodiments of the present invention

### DETAILED DESCRIPTION OF THE INVENTION

Various embodiments of the present invention are related to apparatuses and methods for multi-tier data processing. In multi-tier decoding, two or more data processors are arranged in such a way that data is processed first in a simple and fast processor, and portions of the data that cannot be fully processed in the first processor are then processed in one or more secondary processors that are more capable of processing the data than the first. Thus, data that can be processed rapidly is completed and output, while data that cannot be processed rapidly is passed to a more capable processor without introducing delays in the first processor. Average latency of the system may be reduced by loosening the processing requirements on the first processor, at the expense of worst case latency. In this case, less data will be successfully processed by the first processor and more will be processed in the second processor, but the throughput of the first processor will increase accordingly.

For example, a read channel using multi-tier processing may be provided with a fast and relatively simple detector that first attempts to recover every sector. Sectors that cannot be recovered by this primary detector are passed to a slower, more complex secondary detector. More than two detectors can be employed and sectors that fail are passed to successively more complex detectors. The primary detector can be simpler and more power efficient than the existing single detector since most sectors can be recovered with reduced precision and simplified decoding methods. The secondary detector can be implemented in such a way that decoding performance is maximized at the expense of decoding speed since the secondary detector need only recover sectors that could not be decoded by the primary decoder.

The multi-tier data processing system outputs processed data as it is completed, which may result in an output order different than the input order. In some embodiments, the multi-tier data processing system also include memory management that tracks data as it is processed in each tier. The memory may be arranged in a single block or may have dedicated blocks for each tier. In instances with dedicated memory blocks, slower memory may be used for the slower processors. For example, in some embodiments the primary data processor may have an associated SRAM memory while a secondary data processor has an associated DRAM memory.

The multi-tier data processing system disclosed herein is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

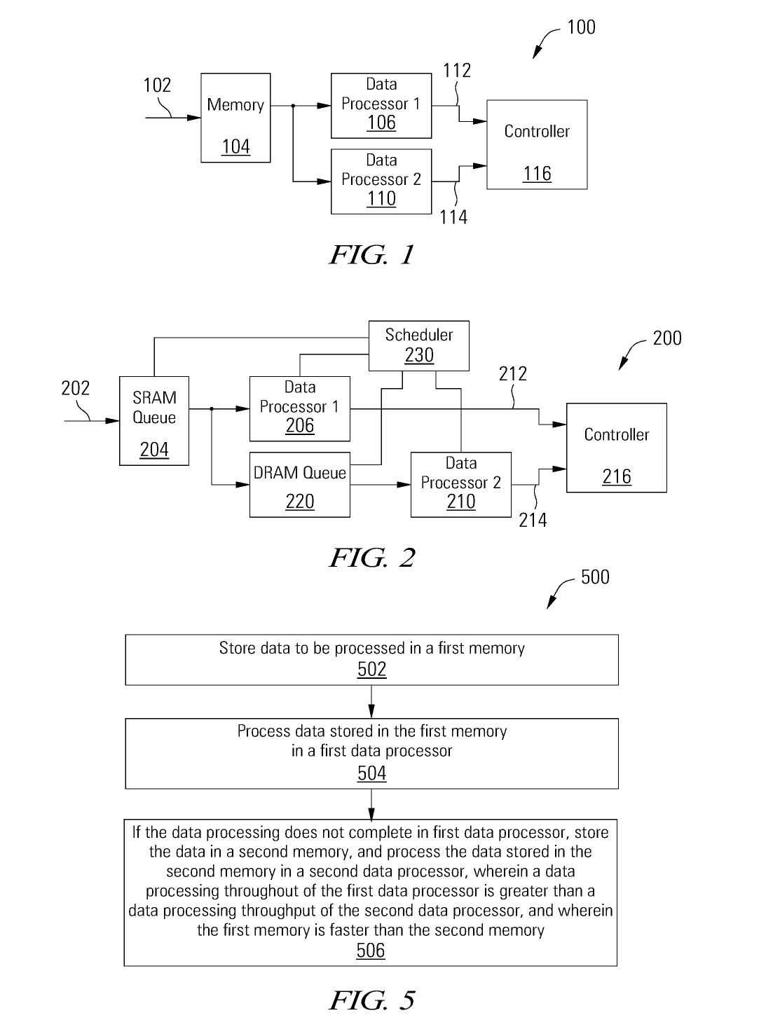

Turning to FIG. 1, a block diagram depicts a multi-tier data processing system 100 in accordance with some embodiments of the present invention. Data is received at an input 102, for example digital data to be checked for errors or for which values are to be detected. The data is stored in a memory 104 such as a buffer or queue. The memory 104 may be any device suitable for storing data values. The stored data from the memory 104 is processed in a first data processor 106, which may be any device for processing data in any manner. Any of the data which cannot be successfully processed in the first data processor 106 is processed in a second data processor 110. The second data processor 110 may also be any device for processing data in any manner. However, in some embodiments, the second data processor 110 is an enhanced data processor with greater capabilities than the first data processor 106, and as such may be able to better process data which the first data processor 106, although perhaps with less throughput. For example, the first data processor 106 and second data processor 110 may both be error detection and correction circuits, with the second data processor 110 able to detect and correct errors in noisier data than the first data processor 106.

Portions of the data which the first data processor 106 is able to successfully processed are provided at an output 112 as they are completed by the first data processor 106, and portions which the first data processor 106 is not able to successfully process are provided to the second data processor 110 for processing. The data provided to the second data processor 110 may be in the original form as received at the input 102, or may be in a partially processed state from the first data processor 106. The data which is successfully processed by the second data processor 110 are provided at an output 114. In some embodiments, additional tiered data processors are provided, each with increasing capabilities. Again, the second data processor 110 may be adapted to provide greater processing capability than the first data processor 106 at the expense of processing speed, because the second data processor 110 need only process data that cannot be successfully processed in the faster first data processor 106. The data at outputs 112 and 114 may be provided to a controller 116 or other recipient for the processed data, such as a hard disk drive controller.

The determination of whether data is successfully processed in a processor may refer in some embodiments to whether the processor is able to arrive at a correct result, for example whether errors can be corrected in data by the processor. In some embodiments, it may refer to whether the processor is able to complete processing of the data within a given time frame, which may be measured in any suitable manner, including for example the number of processing iterations, clock cycles, or elapsed real time.

The data processors 106 and 110, etc, in a multi-tier data processing system 100 may be operable to process different blocks of data simultaneously, with the results provided at outputs 112 and 114 as they become available. The controller 116 is thus operable to receive data from output 112 and output 114 in an order different than the initial order at input 102, and to either re-order the processed data or to use it in its unordered state.

Data may be stored in the memory 104 in any suitable manner for processing in first data processor 106 and second data processor 110. In some embodiments, all data is arranged in a single block in the memory 104, and the multi-tier data processing system 100 is adapted to track the location of segments of data being processed by each of the data processors 106 and 110. In other embodiments, the memory 104 is divided into multiple virtual blocks, each dedicated to one of the data processors 106 and 110.

Turning to FIG. 2, a block diagram depicts a multi-tier data processing system 200 with multi-tier memories in accordance with some embodiments of the present invention. In this embodiment, multiple memories are provided, and in some instances, a memory is provided for each data processor. In some cases, the characteristics of each memory are adapted to the needs of the associated data processor, for example with faster memory devices or architectures provided for faster data processors, and slower memory devices or architectures provided for slower data processors or for data processors with lower throughputs.

In the example illustrated in FIG. 2, data is stored in an SRAM queue 204 (or static random-access memory) as it is received at input 202. Data to be processed is retrieved from SRAM queue 204 and processed in a first data processor 206. Any portions of the data that are successfully processed in first data processor 206 are provided at output 212 to controller 216, which in some embodiments comprises a hard drive controller. Any of the data in SRAM queue 204 that cannot be successfully processed by the first data processor 206 is copied from the SRAM queue 204 to a DRAM queue 220 (or dynamic random-access memory) and from there processed by a second data processor 210. The second data processor 210 has enhanced processing capabilities compared with the first data processor 206, although the throughput of the second data processor 210 may be lower than that of the first data processor 206. This lower throughput may result from the processing algorithms implemented by the second data processor 210, or by the maximum number of processing iterations that may be performed on a block of data in the second data processor 210, or both.

As the data is copied from the SRAM queue 204 to the DRAM queue 220, it may be cleared from the SRAM queue 204, creating space in the SRAM queue 204 for new data to be received from input 202 for processing in the first data processor 206. The throughput of the first data processor 206 may thus be maintained at a high level by transferring processing of difficult data from the first data processor 206 to the second data processor 210 and allowing the first data processor 106 to continue processing data of more normal complexity. Data that is difficult to successfully process may be repeatedly and iteratively processed in the second data processor 210 until processing is successful or until a time limit or a processing limit is reached, then either transferring the data to be processed in yet another tiered processor or signaling an error.

The determination of when data should be processed in the second data processor 210 may be based on whether it can first be successfully processed in the first data processor 206, for example whether errors can be corrected in the data by the first data processor 206 within a given time frame or at all. In other embodiments, the determination may be made before processing of problematic data in the first data processor 206, transferring it for processing in second data processor 210. For example, if a hard drive controller determines that sync marks associated with a sector of data are more difficult to locate than normal, it may assume that the sector data has a particularly low signal to noise ratio and cause the sector data to bypass the first data processor 206 and to be processed in the second data processor 210.

As data is successfully processed by the second data processor 210, the processed data is provided at output 214 to the controller 216. The data blocks processed by the first data processor 206 and second data processor 210 may be received out of order by the controller 216.

The DRAM queue 220 may be slower or have a lower throughput than the SRAM queue 204, based on the throughput or speed of the first data processor 206 and second data processor 210. The SRAM queue 204 and DRAM queue 220 are adapted to provide data to the first data processor 206 and the second data processor 210, respectively, based on their processing speeds or throughputs. In some embodiments, the DRAM queue 220 is shared with other system components, such as the controller 216, or even with external devices.

Data may be divided for processing in the first data processor 206 and second data processor 210 in any suitable blocks. In some embodiments, data is processed in the multi-tier data processing system 200 sector by sector as it is read from a magnetic hard drive.

A scheduler 230 may be provided in the multi-tier data processing system 200 and in various embodiments of the multi-tier data processing system to schedule data flow through processors (e.g., 206 and 210) and through memories (e.g., 204 and 220), causing data to be processed either in the first data processor 206 or the second data processor 210 and determining whether processing is successful. This may be accomplished by reading status signals from first data processor 206 and second data processor 210. The scheduler 230 may also manage the location and transferring of data blocks or sectors in memories (e.g., 204 and 220) in the multi-tier data processing system 200.

Any suitable I/O and bus architectures or other interconnection schemes may be used in the multi-tier data processing system 200 for transferring data to and from memories 204 and 220 and processors 206 and 210.

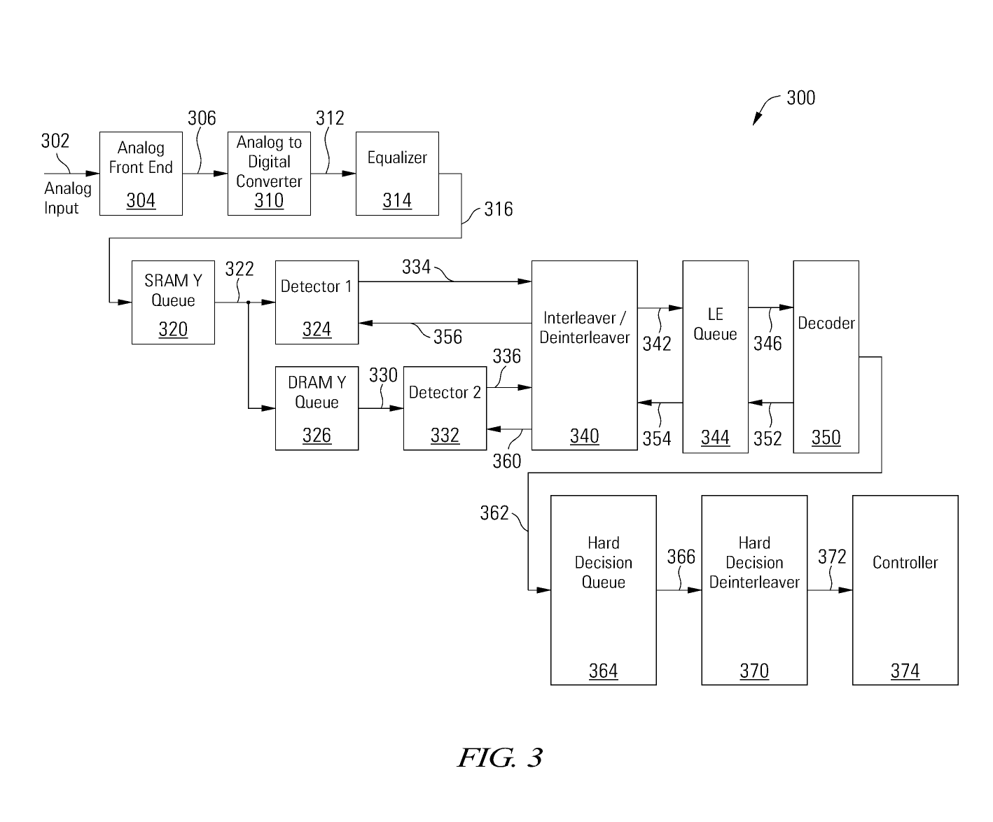

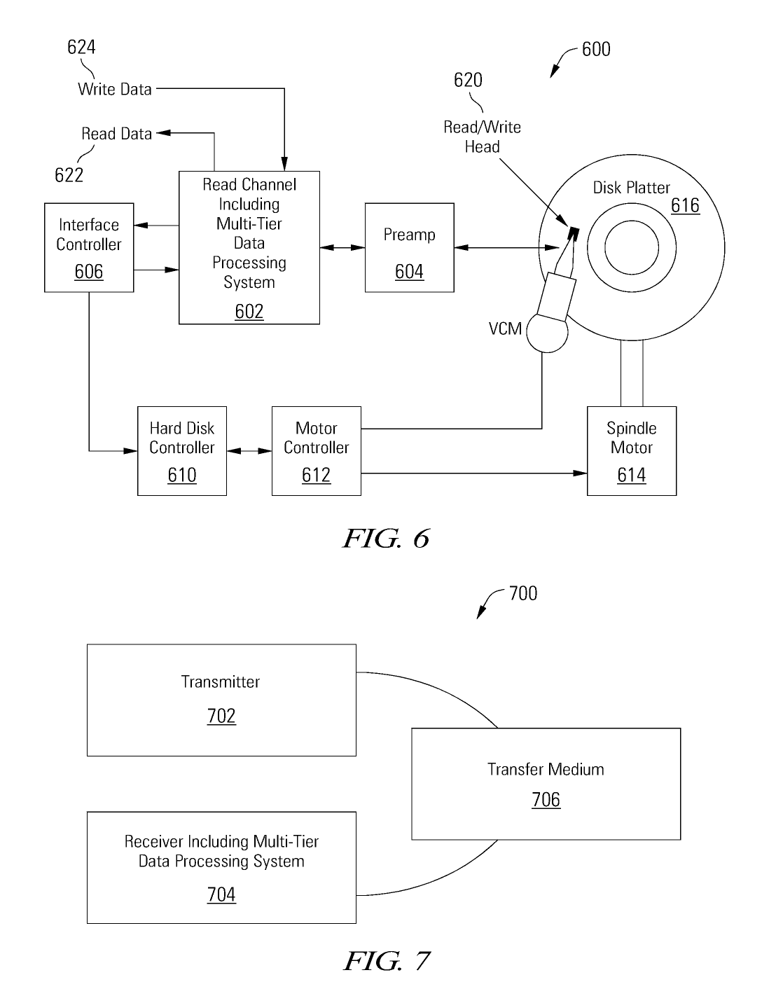

Turning to FIG. 3, a read channel 300 for a magnetic storage device is depicted which includes multi-tier detectors in accordance with some embodiments of the present invention. Read channel 300 includes an analog front end circuit 304 that receives an analog signal 302. Analog front end circuit 304 processes analog signal 302 and provides a processed analog signal 306 to an analog to digital converter circuit 310. Analog front end circuit 304 may include, but is not limited to, an analog filter and an amplifier circuit as are known in the art. Based upon the disclosure provided herein, one of ordinary skill in the art will recognize a variety of circuitry that may be included as part of analog front end circuit 304. In some cases, analog signal 302 is derived from a read/write head assembly (e.g., 620, FIG. 6) that is disposed in relation to a storage medium (e.g., 616, FIG. 6). In other cases, analog signal 302 is derived from a receiver circuit (e.g., 704, FIG. 7) that is operable to receive a signal from a transmission medium (e.g., 706, FIG. 7). The transmission medium may be wired or wireless. Based upon the disclosure provided herein, one of ordinary skill in the art will recognize a variety of sources from which analog input 302 may be derived.

Analog to digital converter circuit 310 converts processed analog signal 306 into a corresponding series of digital samples 312. Analog to digital converter circuit 310 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 312 are provided to an equalizer circuit 314. Equalizer circuit 314 applies an equalization algorithm to digital samples 312 to yield an equalized output 316. In some embodiments of the present invention, equalizer circuit 314 is a digital finite impulse response filter circuit as is known in the art. Equalized output 316 is stored in a channel buffer such as SRAM Y queue 320 until a first data detector circuit 324 is available for processing. It may be possible that equalized output 316 may be received directly from a storage device in, for example, a solid state storage system. In such cases, analog front end circuit 304, analog to digital converter circuit 310 and equalizer circuit 314 may be eliminated where the data is received as a digital data input.

First data detector circuit 324 is operable to apply a data detection algorithm to data 322 from SRAM Y queue 320. In some embodiments of the present invention, first data detector circuit 324 is a Soft Output Viterbi Algorithm (SOVA) data detector circuit as is known in the art. Based upon the disclosure provided herein, one of ordinary skill in the art will recognize a variety of data detector circuits that may be used in relation to different embodiments of the present invention. The first data detector circuit 324 is started based upon availability of a data set from SRAM Y queue 320 or from a central memory circuit 344.

Upon successful completion, first data detector circuit 324 provides detector output 334 to local interleaver circuit 340. Detector output 334 includes soft data. As used herein, the term “soft data” is used in its broadest sense to mean reliability data with each instance of the reliability data indicating a likelihood that the value of a corresponding bit position or group of bit positions has been correctly detected. In some embodiments of the present invention, the soft data or reliability data is log likelihood ratio data as is known in the art. Local interleaver circuit 340 is operable to shuffle sub-portions (i.e., local chunks) of the data set included as detected output 334 and provides an interleaved codeword 342 that is stored to central memory circuit 344 or LE queue. Interleaver circuit 340 may be any circuit known in the art that is capable of shuffling data sets to yield a re-arranged data set.

If a block or sector of data is not successfully processed by first data detector circuit 324, for example if the data does not converge within a given number of local processing iterations in the first data detector circuit 324, that data 322 is copied or moved from SRAM Y queue 320 to DRAM Y queue 326 and processed in second data detector 332. The second data detector 332 has enhanced detection capabilities as compared with the first data detector circuit 324, and may therefore have a lower data throughput. The enhanced detection capabilities may be provided by a different detection architecture or a higher limit on the number of local detection iterations that can be performed, or both. In some embodiments, the second data detector 332 is a noise-predictive maximum-likelihood (NPML) detector implementing the Bahl-Cocke-Jelinek-Raviv (BCJR) algorithm with fast Fourier transform (FFT) belief propagation. In some embodiments, the multiple tiers of data detectors 324 and 332 use the same type of detector, with a greater limit on the number of local detection iterations for secondary tiers providing the enhanced detection. Again, based upon the disclosure provided herein, one of ordinary skill in the art will recognize a variety of data detector circuits that may be used in relation to different embodiments of the present invention. The second data detector 332 is started based upon availability of a data set from DRAM Y queue 326 or from central memory circuit 344.

Upon successful completion, second data detector 332 provides detector output 336 to local interleaver circuit 340. Detector output 336 includes soft data. Local interleaver circuit 340 interleaves data sectors as they are received at detected output 334 from first data detector circuit 324 or detected output 336 from second data detector 332, storing the interleaved codeword 342 in central memory circuit 344.

A decoder 350 is provided in read channel 300 to decode codewords 346 stored in central memory circuit 344. Because processing of data sectors may be completed out of order in first data detector circuit 324 and second data detector 332, the decoder 350 may process data sectors in an order different than the original order at analog signal 302.

In some embodiments of the present invention, the decoder 350 is a low density parity check (LDPC) decoder. Based upon the disclosure provided herein, one of ordinary skill in the art will recognize other decode algorithms that may be used in relation to different embodiments of the present invention. The decoder 350 may apply a data decode algorithm to codewords 346 in a variable number of local iterations within decoder 350, until data values converge and parity check calculations are satisfied.

Where the decoder 350 fails to converge (i.e., fails to yield the originally written data set) and a number of local iterations through decoder 350 exceeds a threshold, the resulting partially decoded output is provided as a decoded output 352 back to central memory circuit 344 where it is stored awaiting another global iteration through either first data detector circuit 324 or second data detector 332, where it is used to guide subsequent detection of a corresponding data set received as equalized output 316 and stored in SRAM Y queue 320. As the decoded output 352 is retrieved from central memory circuit 344 for another global iteration, it is de-interleaved in local interleaver circuit 340, reversing the interleaving performed earlier in local interleaver circuit 340. The de-interleaved decoded output 356 or 360 may be provided to the detector 324 or 332 which last processed the sector, or may be provided to the second data detector 332 to leave the first data detector circuit 324 free to process new data 322 from SRAM Y queue 320. Processing of a sector of data can be transferred from the first data detector circuit 324 to the second data detector 332 during the first global iteration as soon as processing fails to meet a particular criterion such as a convergence metric within a predetermined amount of time, or during subsequent global iterations, either because of a processing failure in the first data detector circuit 324 or because the data failed to converge in the read channel 300 during the first global iteration.

Where the codewords 346 converge (i.e., stabilize on a value presumably corresponding with the originally written data set) in the decoder 350, the resulting decoded output is provided as a hard decisions 362 to a hard decision queue 364 where they are stored. Stored hard decisions 366 from hard decision queue 364 are de-interleaved in a hard decision de-interleaver 370, reversing the process applied in local interleaver circuit 340. The resulting deinterleaved hard decisions 372 are provided to a hard drive controller 374. Again, the sector order in deinterleaved hard decisions 372 may not be the original sector order, due to the processing of some sectors in second data detector 332.

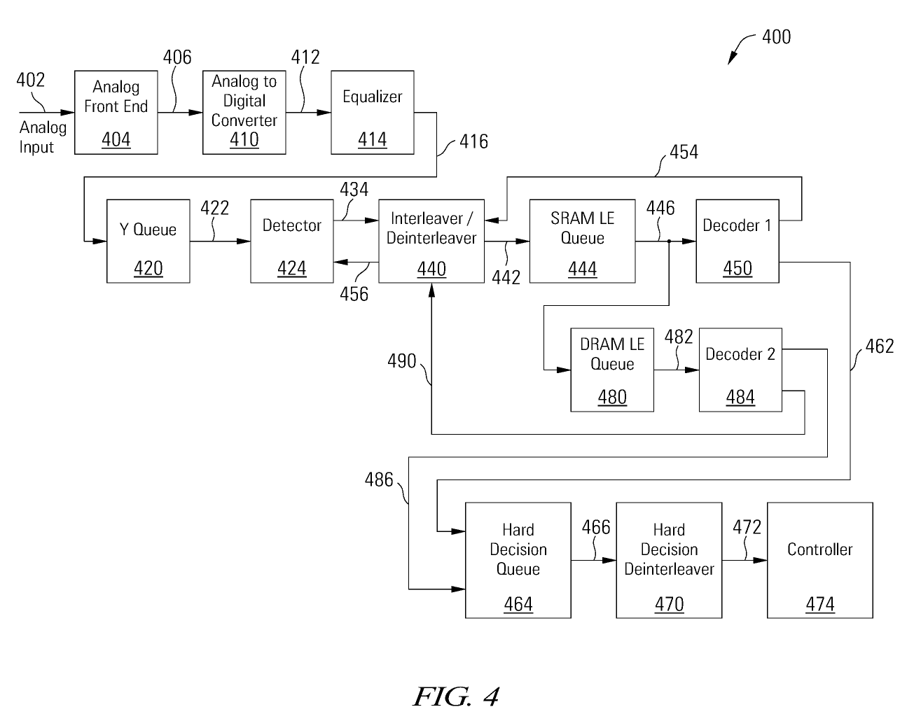

Turning to FIG. 4, a read channel 400 for a magnetic storage device is depicted which includes multi-tier decoders in accordance with some embodiments of the present invention. Read channel 400 includes an analog front end circuit 404 that receives an analog signal 402. Analog front end circuit 404 processes analog signal 402 and provides a processed analog signal 406 to an analog to digital converter circuit 410. Analog front end circuit 404 may include, but is not limited to, an analog filter and an amplifier circuit as are known in the art. Based upon the disclosure provided herein, one of ordinary skill in the art will recognize a variety of circuitry that may be included as part of analog front end circuit 404. In some cases, analog signal 402 is derived from a read/write head assembly (e.g., 620, FIG. 6) that is disposed in relation to a storage medium (e.g., 616, FIG. 6). In other cases, analog signal 402 is derived from a receiver circuit (e.g., 704, FIG. 7) that is operable to receive a signal from a transmission medium (e.g., 706, FIG. 7). The transmission medium may be wired or wireless. Based upon the disclosure provided herein, one of ordinary skill in the art will recognize a variety of sources from which analog input 402 may be derived.

Analog to digital converter circuit 410 converts processed analog signal 406 into a corresponding series of digital samples 412. Digital samples 412 are provided to an equalizer circuit 414. Equalizer circuit 414 applies an equalization algorithm to digital samples 412 to yield an equalized output 416. In some embodiments of the present invention, equalizer circuit 414 is a digital finite impulse response filter circuit as is known in the art. Equalized output 416 is stored in a channel buffer such as Y queue 420 until a data detector circuit 424 is available for processing. It may be possible that equalized output 416 may be received directly from a storage device in, for example, a solid state storage system. In such cases, analog front end circuit 404, analog to digital converter circuit 410 and equalizer circuit 414 may be eliminated where the data is received as a digital data input.

Data detector circuit 424 is operable to apply a data detection algorithm to data 422 from Y queue 420. Data detector circuit 424 may be a SOVA data detector circuit, an NPML BCJR detector with FFT belief propagation, or any other suitable data detector circuit. Based upon the disclosure provided herein, one of ordinary skill in the art will recognize a variety of data detector circuits that may be used in relation to different embodiments of the present invention.

Upon successful completion, data detector circuit 424 provides detector output 434 to local interleaver circuit 440 which is operable to shuffle sub-portions (i.e., local chunks) of the soft data included as detected output 434 and provides an interleaved codeword 442 that is stored to a first central memory circuit or SRAM LE queue 444.

A first decoder 450 is provided in read channel 400 to decode codewords 446 stored in SRAM LE queue 444. The decoder 450 applies a data decoding algorithm to codewords 446 in a variable number of local iterations within decoder 450, until data values converge and parity check calculations are satisfied. If the data values fail to converge within a given number of local decoding iterations or if the number of parity check violations exceeds a threshold, the decoding may be copied to a second tier central memory circuit or DRAM LE queue 480 and processed in a second decoder 484. In some embodiments, data decoding is passed to second decoder 484 during the same global iteration in which decoding fails in the first decoder 450. In other embodiments, data decoding of a particular data sector is passed to the second decoder 484 during subsequent global iterations after failing in an earlier global iteration. In some embodiments of the present invention, decoders 450 and 484 are LDPC decoders, with decoder 484 having additional decoding capability such as multi-level or multi-layer decoding, symbol flipping, or other enhanced decoding techniques. Because of this enhanced decoding, the throughput of second decoder 484 may be less than that of first decoder 450. Based upon the disclosure provided herein, one of ordinary skill in the art will recognize other decode algorithms that may be used in relation to different embodiments of the present invention. The decoders 450 and 484 may apply data decoding algorithms to codewords 446 and 482 in a variable number of local iterations, until data values converge and parity check calculations are satisfied.

The decoded output 454 of first decoder 450 may be returned to the data detector 424 for use in subsequent global iterations, for example if the data fails to converge but the number of parity check violations is not great enough to cause the data to be transferred to second decoder 484 for enhanced decoding. The decoded output 490 of second decoder 484 may also be returned to the data detector 424 for use in subsequent global iterations if the data fails to converge in second decoder 484. During subsequent global iterations, data may be passed to the DRAM LE queue 480 for processing in second decoder 484 rather than in first decoder 450, or may be processed again in first decoder 450 before being transferred to second decoder 484. The determination of whether, during global iterations after the first, to process data in first decoder 450 before transferring to second decoder 484 for enhanced processing may be based on factors such as the log likelihood ratio (LLR) values of the from detector 424 or the number of parity check violations for that data during decoding in a previous global iteration either in first decoder 450 or second decoder 484.

The decoded output 454 and decoded output 490 from decoders 450 and 484 may be passed directly through local interleaver circuit 440 to detector 424 as shown in FIG. 4, or may be passed back through SRAM LE queue 444 or DRAM LE queue 480, respectively.

Where the codewords 446 or 482 converge in the decoders 450 or 484, the resulting decoded output is provided as a hard decisions 462 and 486, respectively, to a hard decision queue 464 where they are stored. Stored hard decisions 466 from hard decision queue 464 are de-interleaved in a hard decision de-interleaver 470, reversing the process applied in local interleaver circuit 440. The resulting deinterleaved hard decisions 472 are provided to a hard drive controller 474. Again, the sector order in deinterleaved hard decisions 472 may not be the original sector order, due to the processing of some sectors in second decoder 484.

Turning to FIG. 5, a flow diagram 500 depicts a method for data processing with a multi-tier data processor in accordance with some embodiments of the present invention. Following flow diagram 500, data to be processed is stored in a first memory. (Block 502) Data stored in the first memory is processed in a first data processor. (Block 504) If the data processing does not complete in the first data processor, the data is stored in a second memory, and is processed in a second data processor. (Block 506) The data processing throughput of the first data processor is greater than a data processing throughput of the second data processor, and in some embodiments, the first memory is faster than the second memory.

Although the multi-tier data processing system disclosed herein is not limited to any particular application, several examples of applications are presented in FIGS. 6 and 7 that benefit from embodiments of the present invention. Turning to FIG. 6, a storage system 600 is illustrated as an example application of a multi-tier data processing system in accordance with some embodiments of the present invention. The storage system 600 includes a read channel circuit 602 with a multi-tier data processing system in accordance with some embodiments of the present invention. Storage system 600 may be, for example, a hard disk drive. Storage system 600 also includes a preamplifier 604, an interface controller 606, a hard disk controller 610, a motor controller 612, a spindle motor 614, a disk platter 616, and a read/write head assembly 620. Interface controller 606 controls addressing and timing of data to/from disk platter 616. The data on disk platter 616 consists of groups of magnetic signals that may be detected by read/write head assembly 620 when the assembly is properly positioned over disk platter 616. In one embodiment, disk platter 616 includes magnetic signals recorded in accordance with either a longitudinal or a perpendicular recording scheme.

In a typical read operation, read/write head assembly 620 is accurately positioned by motor controller 612 over a desired data track on disk platter 616. Motor controller 612 both positions read/write head assembly 620 in relation to disk platter 616 and drives spindle motor 614 by moving read/write head assembly 620 to the proper data track on disk platter 616 under the direction of hard disk controller 610. Spindle motor 614 spins disk platter 616 at a determined spin rate (RPMs). Once read/write head assembly 620 is positioned adjacent the proper data track, magnetic signals representing data on disk platter 616 are sensed by read/write head assembly 620 as disk platter 616 is rotated by spindle motor 614. The sensed magnetic signals are provided as a continuous, minute analog signal representative of the magnetic data on disk platter 616. This minute analog signal is transferred from read/write head assembly 620 to read channel circuit 602 via preamplifier 604. Preamplifier 604 is operable to amplify the minute analog signals accessed from disk platter 616. In turn, read channel circuit 602 decodes and digitizes the received analog signal to recreate the information originally written to disk platter 616. This data is provided as read data 622 to a receiving circuit. As part of decoding the received information, read channel circuit 602 processes the received signal using a multi-tier data processing system. Such a multi-tier data processing system may be implemented consistent with that disclosed above in relation to FIGS. 1-4. In some cases, the data processing may be performed consistent with the flow diagram disclosed above in relation to FIG. 5. A write operation is substantially the opposite of the preceding read operation with write data 624 being provided to read channel circuit 602. This data is then encoded and written to disk platter 616.

It should be noted that storage system 600 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such storage system 600, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

Turning to FIG. 7, a wireless communication system 700 or data transmission device including a receiver 704 with a multi-tier data processing system is shown in accordance with some embodiments of the present invention. Communication system 200 includes a transmitter 202 that is operable to transmit encoded information via a transfer medium 206 as is known in the art. The encoded data is received from transfer medium 206 by receiver 204. Receiver 204 incorporates a multi-tier data processing system. Such a multi-tier data processing system may be implemented consistent with that described above in relation to FIGS. 1-4. In some cases, the data processing may be performed consistent with the flow diagram disclosed above in relation to FIG. 5.

It should be noted that the various blocks discussed in the above application may be implemented in integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the present invention provides novel apparatuses, systems, and methods for a multi-tier data processing system. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system comprising:
an input operable to receive data to be processed;
a first data processor operable to process at least some of the data;
a second data processor operable to process a portion of the data not processed by the first data processor, wherein the first data processor has a higher throughput than the second data processor; and
an output operable to yield processed data from the first data processor and the second data processor.

2. The data processing system of claim 1, wherein the second data processor is operable to process the portion of the data not processed by the first data processor after the first data processor has attempted to process the portion of the data.

3. The data processing system of claim 1, wherein the second data processor is operable to process the portion of the data not processed by the first data processor after the first data processor has failed to successfully process the portion of the data.

4. The data processing system of claim 1, wherein the second data processor has more processing capability than the first data processor.

5. The data processing system of claim 1, further comprising an input memory operable to store the data received at the input and to supply said at least some of the data to the first data processor to be processed.

6. The data processing system of claim 5, further comprising a second memory operable to store said portion of the data retrieved from the input memory to be processed by the second data processor.

7. The data processing system of claim 6, wherein the input memory is faster than the second memory.

8. The data processing system of claim 1, wherein the output is operable to yield the processed data in a different output order than the data to be processed is received at the input.

9. The data processing system of claim 1, wherein the second data processor is operable to process said portion of the data because of a lower signal to noise ratio in said portion of the data than in said at least some of the data.

10. The data processing system of claim 1, further comprising a scheduler operable to detect that the first data processor has unsuccessfully attempted to process said portion of the data and to cause the second data processor to process said portion of the data.

11. The data processing system of claim 1, wherein the first data processor and the second data processor comprise data detectors in a read channel, operable to detect values in the data to be processed.

12. The data processing system of claim 1, wherein the first data processor and the second data processor comprise data decoders in a read channel, operable to correct errors in the data to be processed.

13. The data processing system of claim 1, wherein the data processing system is incorporated in a storage device.

14. The data processing system of claim 1, wherein the data processing system is incorporated in a storage system comprising a redundant array of independent disks.

15. The data processing system of claim 1, wherein the data processing system is incorporated in a transmission system.

16. A method for processing data in a multi-tier data processing system, comprising:
storing data to be processed in a first memory;
processing data stored in the first memory in a first data processor;
for portions of the data stored in the first memory that are not successfully processed in the first data processor, storing the portions of the data in a second memory;
processing the portions of the data stored in the second memory in a second data processor, wherein the first data processor throughput is greater than the second data processor throughput, and wherein the first memory is faster than the second memory; and
outputting processed data from the first data processor and from the second data processor.

17. The method of claim 16, further comprising identifying the portions of the data stored in the first memory that are not successfully processed in the first data processor and causing them to be transferred to the second memory to be processed by the second data processor.

18. The method of claim 17, wherein identifying the portions of the data stored in the first memory that are not successfully processed in the first data processor comprises detecting that errors remain in the portions of the data after the first data processor has attempted to process them.

19. The method of claim 17, wherein identifying the portions of the data stored in the first memory that are not successfully processed in the first data processor comprises detecting that errors remain in the portions of the data after the first data processor has attempted to process them for a predetermined amount of time.

20. A storage system comprising:
a storage medium maintaining a data set;
a read/write head assembly operable to sense the data set on the storage medium and to provide an analog output corresponding to the data set;
an analog to digital converter operable to sample a continuous signal to yield a digital output; and
a multi-tier data processing system comprising:
an input operable to receive data to be processed;
an input memory operable to store the data to be processed;
a first data processor operable to process the data in the input memory;
a second memory operable to store portions of the data from the input memory which are not successfully processed by the first data processor, wherein the input memory is faster than the second memory;
a second data processor operable to process the portions of the data stored in the second memory, wherein the first data processor has a higher throughput than the second data processor and wherein the second data processor has more processing capability than the first data processor; and
an output operable to yield processed data from the first data processor and the second data processor.
